(19) United States
(12) Patent Application Publication
(10) Pub. No.: US 2023/0272139 A1
(43) Pub. Date: Aug. 31, 2023

(54) ADDITIVE MANUFACTURING COMPOSITION FOR 3-D PRINTED OBJECT

(71) Applicant: MITSUBISHI CHEMICAL UK LIMITED, Billingham Durham (GB)

(72) Inventors: Michael Stephen Chisholm, Newton Aycliffe Durham (GB); Philip Andrew Stenson, Newton Aycliffe Durham (GB); Isabell Sarah Karmel, Peterborough Cambridgeshire (GB); Paul Holt, Peterborough Cambridgeshire (GB); Joshua Joseph Lawlor, Peterborough Cambridgeshire (GB)

(21) Appl. No.: 18/006,834

(22) PCT Filed: Jul. 28, 2021
(86) PCT No.: PCT/GB2021/051938

§ 371 Date: Jan. 25, 2023

(30) Foreign Application Priority Data
Jul. 28, 2020 (GB) 2011693.5

(51) Int. Cl. C08F 222/10

(52) U.S. Cl. CPC C08F 222/1065; C08F 222/1063

(57) ABSTRACT

An additive manufacturing composition for a 3-D printed object such as a dental product, typically, a dental prosthesis is described. The composition has: —a. an acrylic polymer having ethyl methacrylate (EM A) residues, b. a crosslinker having at least two reactive terminal groups that are capable of polymerisation, typically, each of the said at least two reactive terminal groups being (alk)acrylate groups, more typically, one or both of the at least two reactive terminal groups are alkacrylate groups, most typically, methacrylate groups, c. a reactive diluent in the form of a flowable liquid at 25° C., d. a suitable initiator and optionally a suitable co-initiator. A process for the production of an additive manufacturing composition, a 3-D printed object, an additive manufacturing process, use of the composition in additive manufacturing and for producing a 3-D printed object and an additive manufacturing vat, bath or cartridge are also described.

The present invention relates to additive manufacturing compositions for a 3-D printed object such as a dental product, typically, a dental prosthesis, more typically dentures, but may be applicable to any dental device such as artificial teeth, denture base, splints, veneers, crowns and bridges, models, appliances and so on. The present invention more specifically relates to additive manufacturing compositions for a 3-D printed object such as a dental product, typically, a dental prosthesis comprising an acrylic polymer having ethyl methacrylate (EMA) residues.

Additive manufacturing is also known as rapid prototyping or 3D printing. Additive manufacturing is a method of creating three-dimensional objects in layers each obtained from a digital representation of the object.

Typically, an object is scanned in 3 dimensions or generated digitally by computer-aided design (CAD) and split into layers of a specified thickness. These layers are sequentially sent to a 3D printer which constructs each layer of the image. After each layer is complete, it is moved away from the imaging source. by the thickness of one layer. The printer then starts the process of creating the next layer on top of the layer just created. These layers combined produce the 3D printed object. There are several different types of 3D printing and thus different methods of creating these layers.

The present invention is concerned with the additive manufacturing of 3D objects using light beam irradiation of photocurable materials. Such techniques include stereolithography (SLA) or digital light processing (DLP) or use of liquid crystal display (LCD) screens. Stereolithography (SLA) uses a laser beam to trace out the shape of each layer and hardens the photosensitive resin in a vat. A digital light processor (DLP) projects sequential voxel planes into a photocurable liquid resin, which then causes the liquid resin to solidify. LCD screens emit visible light which polymerises layers of liquid photopolymer containing a visible light photoinitiator. Successive layers of polymerised material are added in these ways until the object is completely fabricated.

Additive manufacturing is perceived as being advantageous over the conventional method of making dentures that has been practised for many years (since the 1940s). The conventional method involves taking an impression of a patient's mouth, preparing a plaster mould, packing the mould with a dough prepared from mixing acrylic polymer powder(s) with methacrylate monomer(s), followed by curing, demoulding, milling and polishing. This method is both time-consuming and labour-intensive, involving multiple patient visits and production steps.

The use of 3D printing techniques greatly simplifies the process for manufacturing a denture. However, 3D printed dentures are deemed in the market place to be inferior to conventional dentures in terms of mechanical properties. Conventional dentures are known to significantly out-perform the minimum requirements of ISO 20795-1:2013 Dentistry—Base polymers—Part 1: Denture base polymers and ISO 22112:2017 Dentistry—Artificial Teeth for Dental Prostheses. For example, a conventional heat-cured denture base can be expected to exhibit a flexural strength of 90 MPa and flexural modulus 2,700 MPa, well in excess of the flexural strength >65 MPa and flexural modulus >2,000 MPa required by ISO 20795-1:2013.

It would be highly beneficial to provide an additive manufacturing composition which is suitable for producing a dental product such as a prosthesis that has improved mechanical properties, for example, an additive manufactured dental product such as a prosthesis with mechanical properties that are comparable to a conventionally prepared dental products such as prostheses.

The present inventors have now discovered that additive manufacturing compositions containing an acrylic polymer having ethyl methacrylate (EMA) residues produces improved 3D printed objects.

U.S. Pat. No. 9,456,963 (Dentca) relate to photo-curable compositions for artificial teeth and denture base. The compositions of U.S. Pat. No. 9,456,963 comprise a difunctional bisphenol A dimethacrylate, a multifunctional methacrylate, a urethane dimethacrylate, a surface modified silica-based fine particle, a light-photo-polymerization initiator, a colourant, and at least one type of stabilizer which is used to produce denture base with flexural strength >65 MPa and flexural modulus 2750-2900 MPa.

US2014/0131908 (Dentsply) relates to printable polymerizable material systems for making dental products.

It is an aim of the present invention to provide compositions useful in the additive manufacturing of dental prostheses that overcome at least one disadvantage of the prior art. In particular it is an object of the aspects of the present invention to provide an additive manufacturing composition for a 3-D printed object such as a dental product, typically, a dental prosthesis which has improved mechanical properties in the resultant 3D printed object, such as increased flexural strength, flexural modulus and/or high durability.

The present inventors have surprisingly discovered an additive manufacturing composition comprising an acrylic polymer having ethyl methacrylate (EMA) residues has improved mechanical properties in the resultant 3D printed object.

Therefore, compositions comprising such acrylic polymers having ethyl methacrylate (EMA) residues are remarkably effective for producing dental prostheses by additive manufacturing providing advantages such as high flexural strength, flexural modulus and/or shore D hardness.

According to a first aspect of the present invention, there is an additive manufacturing composition for a 3-D printed object such as a dental product, typically, a dental prosthesis comprising:
a) an acrylic polymer having ethyl methacrylate (EMA) residues;
b) a crosslinker having at least two reactive terminal groups that are capable of polymerisation, typically, each of the said at least two reactive terminal groups being (alk)acrylate groups, more typically, one or both of the at least two reactive terminal groups are alkacrylate groups, most typically methacrylate groups;
c) a reactive diluent in the form of a flowable liquid at 25° C.;
d) a suitable initiator and optionally a suitable co-initiator.

Generally, the additive manufacturing composition of the invention is a flowable liquid at additive manufacturing operating temperatures. Typically, component b) and component c) are both liquids at additive manufacturing operating temperatures. By additive manufacturing operating temperatures is meant the temperatures the liquid will be subjected to during the additive manufacturing process such as the feeding, vat, curing and/or storage temperatures.

Generally, the additive manufacturing composition of the invention is a flowable liquid under normal storage conditions such as 5-35° C., or 10-30° C. Typically, component b) is a flowable liquid such as at 5-35° C., or 10-30° C.

Generally, when component b) is not a liquid at 25° C. then component c) will dissolve component b).

In the present invention, if component b) is a flowable liquid at 25° C., the reactive diluent preferably has a viscosity below that of component b) at 25° C.; It will be appreciated that component a) is at least partially dissolved, such as at least 25%, more typically 50%, most typically, 75%, optionally fully dissolved in the composition in order to provide a composition that is a flowable liquid at additive manufacturing operating temperatures, for example at 10° C. to 50° C., typically, 15° C. to 40° C., more typically 18° C. to 30° C.

### Acrylic Polymer

The acrylic polymer according to the compositions of the present invention comprises ethyl methacrylate (EMA) residues i.e.

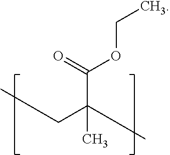

Suitably, the acrylic polymer comprises more than 50%, typically more than 60%, more typically more than 70%, even more typically more than 80% or most typically more than 90% or especially about 100% EMA residues relative to total monomer residues.

Therefore, the acrylic polymer may be a (co)polymer having ethyl methacrylate (EMA) residues. Typically, the acrylic polymer is a homopolymer of ethyl methacrylate (EMA).

In some embodiments, the acrylic polymer may be an acrylic copolymer having ethyl methacrylate (EMA) residues and further comprising residues of one or more further acrylic and/or vinyl comonomers.

Therefore, the acrylic polymer may have less than 50%, typically less than 40%, more typically less than 30%, even more typically less than 20% or most typically less than 10% further acrylic and/or vinyl residues relative to total monomer residues or especially about 0% further acrylic and/or vinyl residues relative to total monomer residues.

Suitably, the further acrylic residues of the acrylic polymer described herein may be residues of acrylic monomers selected from one or more alkyl, cycloalkyl or alkenyl(alk)acrylates; alkyl, cycloalkyl or alkenyl(alk)acrylic acids; functionalised (alk)acrylates; and di(alk)acrylates.

The further acrylic residues may be residues of one or more C₁-C₁₀ alkyl, cycloalkyl or alkenyl (C₀-C₁alk)acrylate or acrylic acid monomers.

Suitable comonomers may therefore be selected from one or more of methyl methacrylate, methyl acrylate, ethyl acrylate, n-butyl acrylate, iso-butyl acrylate, t-butyl acrylate, n-butyl methacrylate, iso-butyl methacrylate, t-butyl methacrylate, 2-ethylhexyl methacrylate, 2-ethylhexyl acrylate, lauryl methacrylate, lauryl acrylate, cyclohexyl acrylate, cyclohexyl methacrylate, isobornyl acrylate, isobornyl methacrylate, methacrylic acid, acrylic acid; allyl methacrylate, ethylene glycol dimethacrylate, ethylene glycol diacrylate, hydroxyl-functional acrylates such as 2-hydroxyethyl methacrylate, hydroxypropylethyl methacrylate, 2-hydroxyethyl acrylate, and hydroxypropyl acrylate; 1,4-butanediol dimethacrylate, 1,4-butanediol diacrylate, 1,6-hexanediol dimethacrylate and/or 1,6-hexanediol diacrylate.

In embodiments where the acrylic polymer is an acrylic copolymer, typically the acrylic copolymer is a copolymer of ethyl methacrylate (EMA) with methyl methacrylate (MMA), iso-butyl methacrylate (iBMA) or n-butyl methacrylate (nBMA)

Suitably, the vinyl comonomers of the acrylic polymer described herein may be vinyl monomers selected from one or more of styrene, vinyl pyrrolidone, vinyl pyridine, vinyl acetate, vinyl toluene, alphamethyl styrene, and divinyl benzene.

Preferably, the comonomer is a further (i.e. different) alkyl or cycloalkyl(alk)acrylate, alkyl or cycloalkyl(alk)acrylic acid or functionalised (alk)acrylates, more preferably, selected from methyl acrylate, ethyl acrylate, n-butyl acrylate, iso-butyl acrylate, t-butyl acrylate, n-butyl methacrylate, iso-butyl methacrylate, t-butyl methacrylate, 2-ethylhexyl methacrylate, 2-ethylhexyl acrylate, lauryl methacrylate, lauryl acrylate, cyclohexyl acrylate, cyclohexyl methacrylate, isobornyl acrylate, isobornyl methacrylate, methacrylic acid, acrylic acid; hydroxyl-functional acrylates such as 2-hydroxyethyl methacrylate, hydroxypropylethyl methacrylate, 2-hydroxyethyl acrylate, and hydroxypropyl acrylate.

Suitably, the isolated acrylic polymer is solid, typically the isolated acrylic polymer is a powder, more typically, the isolated acrylic polymer is a powder at room temperature, especially at 25° C.

Suitably, the acrylic polymer may be prepared using any suitable known polymerisation method, such as, but not limited to: bulk, suspension, emulsion, solution polymerisation or any derivative thereof.

Preferably the acrylic polymer is prepared by suspension polymerisation. Accordingly, the acrylic polymer is preferably a bead polymer. Suspension polymerisation of acrylic monomers is well known and has been described in a number of literature reviews, for example Suspension Polymerisation; H. G. Yuan, G. Kalfas, and W. H. Ray; JMS-REV. Macromol. Chem. Phys.; C31(2&3); 215-299; 1991.

Suspension polymerisation involves the polymerisation of monomers in a dispersed phase. The continuous phase is normally water. Suitable dispersing agents are well known in the art and include modified cellulose polymers (e.g. hydroxyethyl, hydroxypropyl, hydroxypropyl methyl), polyacrylic acid, polymethacrylic acid, partially and fully neutralised versions of these acids, poly(vinyl alcohol), poly(vinyl alcohol-co-vinyl acetate) copolymers amongst others. The dispersion of monomers in the continuous phase is normally agitated at high speed throughout the polymerisation process to help keep the dispersion stable, to enable good heat transfer between the continuous phase and the dispersed droplets or particles and to control bead particle size.

As the polymerisation proceeds, the monomers in the dispersed phase react to form a polymer which remains in the dispersed phase in spherical bead form. The reaction temperature may vary according to the type of monomers and initiator which are used and is typically between 20 and 150° C., for example in the range 50-120° C. The mean particle size of the resultant polymer beads is typically between 10 microns and 800 microns, for example in the range 15 to 600 microns.

In any case, the preferred mean particle size range of the acrylic polymer of the present invention is 20 to 200 microns, preferably 30 to 150 microns, more preferably 35 to 120 microns. Mean particle size may be determined using a Coulter LS230 laser diffraction instrument.

Suitably, the acrylic polymer is at least 0.2 wt %, typically at least 1 wt %, more typically at least 2 wt %, most typically, at least 3 wt % of the total weight of the composition.

Suitably, the acrylic polymer is up to 40 wt %, typically up to 20 wt %, more typically up to 15 wt % of the total weight of the composition.

Accordingly. the acrylic polymer may be between 0.2 to 40 wt %, typically between 1 to 20 wt %, more typically between 2 to 15 wt %, most typically, 3 to 15 wt % of the total weight of the composition.

The acrylic polymer according to any of the aspects of the present invention may have the weight average molecular weight (Mw) of between 5,000 Daltons and 3,000,000 Daltons, typically, between 50,000 Daltons and 1,500,000 Daltons, more typically, between 100,000 and 800,000 Daltons, most typically, between 200,000 and 600,000 Daltons. Molecular weight may be determined for this purpose by gel permeation chromatography (GPC).

### Crosslinker

The additive manufacturing composition for a 3-D printed object such as a dental product, typically, a dental prosthesis according to the first aspect of the present invention comprises a crosslinker having at least two reactive terminal groups, for example (alk)acrylate or vinyl groups.

The crosslinker according to the aspects of the present invention comprises at least two reactive terminal groups and may be connected by a bridging group. Typically, therefore, the crosslinker defined herein comprises at least two reactive terminal groups that are spaced apart by a bridging group.

Typically, one or both or all of the said at least two reactive terminal groups is a vinyl or (alk)acrylate group, more typically, one or both or all of the at least two reactive terminal groups are alkacrylate groups, most typically, one or both or all are methacrylate groups.

The bridging group may include a chain of at least 8 carbon or carbon and heteroatoms in the bridge between the reactive terminal groups, preferably, the heteroatoms are selected from silicon, sulphur, oxygen or nitrogen, more preferably, oxygen or nitrogen.

Accordingly, the bridging group may be any suitable organic group. For example, the bridging group may be an aliphatic including alicyclic or aromatic group or combination thereof. Typical examples are alkyl, alkenyl or cycloalkyl groups or a mixture of such forming a mixed group. The bridging group may contain one or more heteroatoms and therefore it is understood that said bridging group may be a heteroaliphatic, including heteroalicyclic or heteroaromatic or a combination thereof. Typical examples are heteroalkyl, heteroalkenyl or heterocycloalkyl groups or a mixture of such forming a mixed group.

Typically, the bridging group may be an alkyl, alkenyl, cycloalkyl, ether, polyether, polyester or polyurethane group with at least 8 atoms in the bridge.

Typically, the bridging group may be an alkyl, alkenyl, cycloalkyl, ether, polyether, polyester or polyurethane group with up to 400 atoms in the bridge.

Typically, the bridging group may be an alkyl, alkenyl, cycloalkyl, ether, polyether, polyester or polyurethane group with from 8 to 400 atoms in the bridge, more typically, 8 to 200 atoms in the bridge, most typically, 8 to 100 atoms in the bridge.

The bridging group may be an oligomeric group.

Suitably, the bridging group may be selected from a polyurethane, bisphenol A or bisphenol A ethoxylate group.

Suitably, the crosslinker may be selected from the groups consisting of one or more of urethane dimethacrylate (UDMA), bisphenol A dimethacrylate (BPAMA), bisphenol A ethoxylate dimethacrylate (BPAEDMA), and bisphenol A-glycidyl methacrylate (“bis-GMA”), typically one or more of Ebecryl® 4859 and bisphenol A (EO)₄ dimethacrylate.

The bridging group of the crosslinker may have a molecular weight (Mw) of 150 g/mol to 5,000 g/mol.

It is understood that the molecular weight of the bridging group is equal to the total molecular weight of the crosslinker, minus the molecular weight of the reactive terminal groups. The molecular weight of the bridging group can be used to indicate the effective distance between the at least two reactive terminal groups.

Suitably, the crosslinker may be at least 5 wt %, typically at least 10 wt %, more typically at least 15 wt % of the total weight of the composition.

Suitably, the crosslinker is up to 94 wt %, typically up to 90 wt %. more typically up to 85 wt % of the total weight of the composition.

Suitably, the crosslinker is between 5 to 95 wt %, typically between 10 to 90 wt %, more typically between 15 to 85 wt % of the total weight of the composition.

The crosslinker may be a liquid at additive manufacturing operating temperature. Typically, it may be a liquid with a viscosity at 25° C. in the range 200 to 800,000 cP. Alternatively, it may be a solid at this temperature.

The crosslinker component b) may also be a mixture of more than one crosslinker as defined herein.

### A Reactive Diluent

The composition according to the aspects of the present invention comprises a reactive diluent in the form of a flowable liquid at 25° C. Preferably, if component b) is a liquid, the reactive diluent has a viscosity below that of component (b). Therefore, the reactive diluent is typically a flowable liquid at additive manufacturing operating temperatures, for example, a flowable liquid at room temperature.

The reactive diluent may have a viscosity at 25° C. in the range of 1 to 8,000 cP, typically 2 to 6,000 cP, more typically, 5 to 2,000 cP.

The reactive diluent defined herein typically comprises one or more primary monomers having at least two reactive monomer units or a single reactive monomer unit and a bulky side group and optionally, one or more auxiliary monomers. Suitably, the reactive diluent primary monomer is a di or poly(alk)acrylate, such as a di-, tri- or tetraalkacrylate, more typically, a dimethacrylate; or a bulky alkyl, cyclic or aryl (alk)acrylate or a combination thereof such as alkaryl or aralkyl, wherein the bulky alkyl, cyclic or aryl side group may be selected from t-butyl, isobornyl, cyclohexyl, dicyclopentenyl, dihydrodicyclopentadienyl, adamantyl, 4-t-butylcyclohexyl, 3,3,5-trimethylcyclohexyl, tetrahydrofurfuryl benzyl, 2-phenoxyethyl and phenyl. When two or more, the (alk)acrylate groups may be separated by a di- or polyvalent alkane or alkylether (which latter may include multiple ether groups) and may be linear or branched and may be C2 to C50, more typically, C2 to C30 and most typically, C2 to C20.

The reactive diluent defined herein may comprise one or more primary monomers having bulky side groups. Suitably, one or more primary monomers are bulky side group (alk)acrylates typically, wherein the bulky side group is a bulky alkyl, cyclic or aryl side group, such as isobornyl methacrylate (IBOMA), cyclohexyl methacrylate (CHMA) and t-butyl methacrylate (TBMA), more typically isobornyl methacrylate (IBOMA).

The compositions of the invention comprising a reactive diluent comprising a primary monomer having bulky side groups, typically a bulky side group (alk)acrylate such as isobornyl methacrylate (IBOMA) are remarkably effective for producing dental prostheses by additive manufacturing with a surprisingly high flexural strength and flexural modulus.

Suitably, the reactive diluent primary monomer may be selected from one or more of ethylene glycol dimethacrylate (EGDMA), diethylene glycol dimethacrylate (DEGDMA), triethylene glycol dimethacrylate (TEGDMA), tetraethyleneglycol dimethacrylate, polyethyleneglycol dimethacrylate, 2,2-bis[4(methacryloxyethoxy)phenyl]propane, 1,6-hexanediol dimethacrylate, tripropylene glycol dimethacrylate, butanediol dimethacrylate, neopentyl glycol dimethacrylate, dipropylene glycol dimethacrylate, tripropylene glycol trimethacrylate, trimethylol propane trimethacrylate, ethoxylated trimethylolpropane trimethacrylate, pentaerythritol trimethacrylate, propoxylated glyceryl trimethacrylate, propoxylated trimethylolpropane trimethacrylate, ditrimethylolpropane tetramethacrylate, ditrimethylol pentaerythritol tetramethacrylate, dipentaerythritol hexamethacrylate, isobornyl methacrylate (IBOMA), cyclohexyl methacrylate (CHMA), t-butyl methacrylate (TBMA), dicyclopentenyl methacrylate, dihydrodicyclopentadienyl methacrylate, adamantyl methacrylate, 4-t-butylcyclohexyl methacrylate, 3,3,5-trimethylcyclohexyl methacrylate, tetrahydrofurfuryl methacrylate, benzyl methacrylate, 2-phenoxyethylmethacrylate and phenyl methacrylate, typically triethylene glycol dimethacrylate (TEGDMA), isobornyl methacrylate (IBOMA), cyclohexyl methacrylate (CHMA) and t-butyl methacrylate (TBMA).

The reactive diluent auxiliary monomer may be a monofunctional monomer selected from one or more of methacrylic acid, itaconic acid, 2-hydroxyethyl methacrylate, hydroxypropyl methacrylate and alpha-methylene-gamma-butyrolactone.

The amount of auxiliary monomer that can be used is up to 50 wt % of the total amount of reactive diluent, more typically, up to 40, 30 or 20 wt %.

In the composition according to the aspects of the present invention, it will be appreciated that if neither the crosslinker of part b) nor the reactive diluent of part c) are mixtures then the reactive diluent of part (iii) is not the same compound as the crosslinker component of part (ii). In the case of mixtures, the viscosity of the mixture of part c) will be less than the viscosity of component b) whether a mixture or otherwise.

The composition of the aspects of the present invention comprises a reactive diluent in an amount of at least 5 wt %, typically at least 10 wt %, more typically at least 15 wt % of the total weight of the composition.

Suitably, the reactive diluent is up to 85 wt %, typically up to 80 wt %. more typically up to 75 wt % of the total weight of the composition.

Suitably, the reactive diluent is between 5 to 85 wt %, typically between 10 to 80 wt %, more typically between 15 to 75 wt % of the total weight of the composition.

The reactive diluent component c) may also be a mixture of more than one reactive diluent as defined herein.

### Initiator

The additive manufacturing compositions described herein comprise a suitable initiator and optionally a suitable co-initiator. It is understood that the initiator and co-initiator used herein are suitable for use in an additive manufacturing process as claimed.

Suitable initiators and co-initiators are well known to the skilled person.

Suitably, the initiator and/or co-initiator may be a photo-initiator. A photo-initiator causes polymerisation to be initiated upon exposure to UV and/or visible wavelengths of light.

UV light is defined as electromagnetic radiation with a wavelength in the range of approximately 10-420 nm, and visible light is defined as electromagnetic radiation with a wavelength in the range of approximately 380-800 nm.

Typically, the suitable initiator and/or co-initiator will absorb strongly at the same wavelength as the light source of the 3D printer.

Examples of suitable initiators include, but are not limited to, one or more of 5,7-diiodo-3-butoxy-6-fluorone, Ethyl (2,4,6-trmethylbenzoyl) phenyl phosphinate, acetophenone, anisoin, anthraquinone, (benzene)trcarbonylchromium, benzil, benzoin, benzoin ethyl ether, benzoin isobutyl either, benzoin methyl ether, benzophenone, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(II)hexafluorophosphate, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzyl, 2,5-dimethylbenzophenone, 3,4-dimethylbenzophenone, 4′-ethoxyacetophenone, 2-ethylanthraquinone, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methylbenzoylformate, 2-methyl-4′-(methylthio)-2-morpholinopropio-phenone, phenanthrenequinone, 4′-phenoxyacetophenone, thioxanthen-9-one, triacrylsulfonium hexafluoroantimonate salts, triarylsulfonium hexafluorophosphate salts, and (bis)acylphosphine oxide.

Typically, the (bis)acylphosphine oxide may be selected from one or more of acylphosphine oxides include 2,4,6-trimethylbenzoyldiphenylphosphine oxide, 2,6-dimethyoxybenzoyldiphenylphosphine oxide, 2,6-dichlorobenzoyldiphenylphosphine oxide, 2,4,6-trimethylbenzoylmethoxyphenylphosphine oxide, 2,4,6-trimethylbenzoylethoxyphenylphosphine oxide, 2,3,5,6-tetramethylbenzoyldiphenylphosphine oxide, and benzoyl di-(2,6-dimethylphenyl)phosphonate. Examples of the bisacylphosphine oxides include bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-prophylphenylphosphine oxide, bis-(2,6-dichlorobenzoyl)-1-naphthylphosphine oxide, bis-(2,6-dimethoxybenzoyl)-2,4,4-trmethylpentylphosphine oxide, bis-(2,6-dimethoxybenzoyl)-2,5-dimethylphenylphosphine oxide, bis-(2,4,6-trimethylbenzoyl)phenylphosphine oxide, and (2,5,6-trimethylbenzoyl)-2,4,4-timethylpentylphosphine oxide.

It was surprisingly found that the composition comprising a photoinitiator as defined herein, for example a (bis)acylphosphine oxide compound as the photo-initiator, showed an excellent curability of a thin-layer surface which is an important property for three-dimensional printing. A photo-initiator used for artificial teeth and a denture base may typically be selected from (bis)acylphosphine oxide or camphorquinone

According to the aspects of the present invention, preferred initiators may be selected from the list consisting of camphorquinone, 2,4,6-trimethylbenzoyldiphenylphosphine oxide (TPO), ethyl (2,4,6-trimethylbenzoyl) phenyl phosphinate (available as Speedcure TPO-L) and bis(2,4,6-trimethylbenzoyl)-phenylphosphineoxide photoinitiator (BAPO), (available as Irgacure 819)

A co-initiator may be used in combination with the photo-initiator. The co-initiator may comprise a tertiary amine and/or a sulfinate compound. Accordingly, examples of co-initiators include ethyl 4-(N,N-dimethylamino) benzoate, 2-(ethylhexyl)-4-(N,N-dimethylamino) benzoate, N,N-dimethylaminoethyl methacrylate, N,N-dimethylaminophenethyl alcohol, sodium benzenesulfinate, and sodium toluenesulfinate.

Unless indicated to the contrary, an “organic moiety” is intended to mean any hydrocarbyl group or group of hydrocarbyl groups, for example one or more hydrocarbyl group selected from an alkyl group, cycloalkyl group, aromatic group, heteroaromatic group, heterocyclic group, alkenyl group, any of said groups being substituted by or linked together by an aldehyde, halogen, ketone, carboxylic acid or ester, ether, thioether, amine, amide functionality.

The amount of photo-initiator that should be used may be from about 0.01% to about 5%, preferably from about 0.5% to about 3% based on the total weight of the composition.

The amount of co-initiator that should be used may be from about 0.5% to about 10%, preferably from about 1% to about 3% based on the total weight of the composition.

### Additives

The composition according to any of the aspects of the present invention may further comprise one or more additives. The additive may be selected from one or more of a filler, stabiliser, impact modifier, colourant, flow modifier and/or an antistatic agent, more typically, the additives are selected from one or more of a filler, colourant and a stabiliser.

### Filler

The compositions of the present invention may contain a filler. Typically, the filler can be suspended in the printable polymerizable resin. The filler may be an organic filler or an inorganic filler, or a combination of an organic and inorganic filler. The filler of the present invention may be a naturally-occurring or synthetic filler.

An inorganic filler according to the present invention may include materials such as silica, silicates, glasses, iron oxides, silicon nitrides, titanium dioxide, talc and quartz.

Silicas may be selected from one or more of fused silica, synthetic silica, amorphous silica, silanized fumed silica.

Silicates may be selected from one or more of alumina silicate, barium silicate, borosilicate glasses, lithium alumina silicate, lithium silicate, kaolin, strontium borosilicate. Typically, glasses may be selected from one or more of silanized barium boron aluminosilicate and silanized fluoride barium boron aluminosilicate.

Glasses may be selected from one or more of barium, calcium, cerium, lead, lithium, strontium, tin, zinc, zirconium, and aluminium-based glasses. For example, glasses may be borosilicate glass, fluroaluminium borosilicate glass, lithium borosilicate glass, glass ceramic, soda glass.

Silica particle may have an average diameter of less than about 300 nm, typically less than 200 nm. Silica particles are typically substantially spherical and/or substantially non-porous. Suitable nano-sized silicas are commercially available from DeGussa AG, (Hanau, Germany) under product name Aerosil OX-50, -130, -150, and -200 or from Cabot Corp (Tuscola, Ill.) under product name Cab-o-sil M5.

An inorganic filler may be surface-treated with a coupling agent, such as a silane compound. Surface-treated inorganic filler particles improve bonding between the particles and resin matrix.

Silica particles may be coated in an oxide which may contain zirconium, silicon and oxygen atoms. The oxide coating layers may be functionalised resulting in surface-modified silica particles. Surface-modified silica particles provide a stable dispersion in the solution before the composition is used since the particles do not aggregate and are not settled after standing for a certain period of time at room temperature. The surface-modified particles are well dispersed in the photo-curable composition, and thus, help to achieve a substantially homogenous composition.

When a surface of silica particle is modified or coated with silane treatment agents having functional groups such as acryl group or methacryl group that can participate in the polymerization reaction in a methacrylate composition, the silica particle is referred to as functionalized silane-treated particles. If the surface of silica particle is not modified or coated, the silica particle is referred to as unfunctionalized silane-treated silica.

A surface modifying agent having functional group which can be reacted in the polymerization during curing may include, for example, w-methacryloxyalkyl trimethoxysilane having 3 to 15 carbon atoms between a methacryloxy group and a silicon atom, such as methacryloxypropyltrimethoxysilane, w-methacryloxyalkyl triethoxysilane having 3 to 15 carbon atoms between a methacryloxy group and a silicon atom, vinyltrimethoxysilane, vinyltriethoxysilane, vinyltriacetoxysilane, and γ-glycidoxypropyltrimethoxysilane. Typically, silane treatment agent includes 3-methacryloxypropyltrimethoxysilane, 8-methacryloyloxyoctyltrimethoxysilane, 9-methacryloyloxynonyltrimethoxysilane, 10-methacryloyloxydecyltrimethoxysilane, 11-methacryloyloxyundecyltrimethoxysilane, 11-methacryloyloxyundecyldichloromethylsilane, and 11-methacryloyloxyundecyltrichlorosilane.

Examples of commercially available surface modifying agents include Genosil GF31, Genosil XL33, Genosil GF80 and GF82 from Wacker Chemie AG and Aerosil R7200 from Evonik.

The surface modifying agents listed above may be used alone, or in combination in the embodiments of the present invention.

Alternatively, the filler of the present invention may be an organic filler.

Such an organic filler may include one or more of poly(methyl methacrylate) (PMMA), crosslinked polyacrylates, crosslinked PMMA beads, poly(methyl methacrylate-co-butyl methacrylate), copolymers of methyl methacrylate and acrylate monomers, thermoplastic and crosslinked polyurethanes, polyethylene, polypropylene, polycarbonates and polyepoxides.

Preferably, the organic fillers can dissolve or suspend in printable polymerizable resin.

Other fillers that may be added to the composition includes fibres, such as either inorganic fibres (for example glass fibres or alumina fibres) or organic fibres (such as polymer fibres, for example, nylon fibres, polyamide fibres, viscose rayon fibres, polyester fibres, etc. Such fibres may include colorants such as dyes or pigments.

The filler component may not be present or may be present in an amount of at least about 1 or 2 wt % of the overall composition. Furthermore, the filler component may be present in an amount less than about 75 wt % and more preferably less than about 70 or 65 wt % of the overall composition. For example, the filler component may be present in a range of about 0 to about 75 wt %, and preferably from about 1 to about 70 wt %, more preferably, 2 to about 65 wt % of the overall composition.

### Impact Modifier

Impact modifiers are additives that alter the impact strength of materials. Suitably, an impact modifier may be added to improve the impact strength of a material.

An impact modifier may be added to the additive manufacturing composition as described herein. Suitably, the composition according to aspects of the present invention may comprise an impact modifier. The composition according to aspects of the present invention may comprise at least 0.2 or 0.5 wt % impact modifier, such as at least 1 or 2 wt %. Typically, if present, the composition comprises less than 20 wt % impact modifier based on the total weight of the composition.

The impact modifier may be added as free impact modifier. The impact modifier may be added independently as particles such as impact modified polymer beads and/or core/shell particles which may incorporate rubbery oligomers, reactive oligomers and (co)polymers. Alternatively, the rubbery oligomers, reactive oligomers and (co)polymers may be added directly. The impact modifier may also be incorporated into any of parts a)-c) of the composition.

The impact modifier may be added to the acrylic polymer of the additive manufacturing composition as described below.

The acrylic polymer may be in the form of a bead that may be produced by suspension polymerisation, When the acrylic polymer is in the form of a bead, the impact modifier may be incorporated into the acrylic polymer bead during the polymerisation process, typically, during the suspension polymerisation process to produce an impact modified polymer bead.

The impact modifier may be in the form of a core/shell particle. Such core/shell impact modifier particles are known to those skilled in the art. For example, such particles can have a rubbery core and glassy outer shell or a glassy core and a rubbery shell. In addition, there may be be further shells in either case which may or may not be rubbery. Rubbery in this sense means those (co)polymers having relatively lower Tg and glassy means those having relatively higher Tg. Irrespective of whether the core/shell impact modifiers have a rubbery core or rubbery shell, they usually have a glassy outer shell for ease of handling. Typically, core/shell particles may be produced using emulsion polymerisation techniques.

Accordingly, an impact modifier includes an additive that improves the impact strength of the composition and therefore the impact strength of materials or articles produced therefrom.

Suitably, the impact modifier may improve the impact strength of the additive manufactured product from the compositions of the present invention by at least 10%, such as at least 20% or 30% compared to one not containing the impact modifier. Typically, the improved impact strength as defined above is measured by notched Izod impact strength according to the method described in ASTM D256 or ISO180. In impact modifiers used for the present invention, there may be elastomeric regions. The impact modifier may have discrete elastomeric phases in the impact modifier. Still further, in addition or alternatively to forming elastomeric regions itself, the impact modifier may be polymerised into the polymer or oligomer components to form elastomeric regions in the polymer chains. Even further the impact modifier may crosslink the matrix (co)polymer and provide elastomeric regions in the resulting network or form branches off the matrix (co)polymer.

As mentioned, suitable impact modifiers of the aspects of the present invention are those known to one of ordinary skill in the art, and include, but are not limited to, core-shell particles and modified beads.

Typically, the impact modifiers are selected from those based on acrylic (such as n-butyl acrylate based core-shell particles), styrene (such as MBS and SBR), silicone (including silicone-acrylic), nitrile rubber, isoprene such as polyisoprene, butadiene such as polybutadiene, isobutylene, aliphatic polyurethanes, polyether oligomers, polyester oligomers, Suitable impact modifier (co)polymers include polyisobutylene, polybutadiene, polyisoprene, nitrile rubber and aliphatic polyurethane (co)polymers.

Nitrile rubber derived impact modifiers are synthetic rubbers that are commonly derived from the random polymerization of acrylonitrile with butadiene by free radical catalysis.

Such impact modifiers may have different levels of acrylonitrile, and, for purposes of the present invention, it is desired that the bound acrylonitrile content be in the range of from about 18 to about 50% w/w nitrile rubber. A typical nitrile rubber component is an acrylonitrile-butadiene copolymer.

Examples of impact modifiers include rubber impact modifiers, acrylic impact modifiers and rubber modified PMMAs.

Suitable commercially available impact modifiers of the present invention include Durastrength® acrylic impact modifiers from Arkema; Clearstrength® MBS (MMA-butadiene styrene) impact modifiers from Arkema; Metablen® W type acrylic impact modifier from MCC; Metablen® C-type MBS type impact modifiers from MCC; Metablen® S-type silicone acrylic impact modifier from MCC; Chemigum® poly(acrylonitrile-co-butadiene) elastomers from Omnova Solutions; Hypro™ polybutadiene reactive liquid rubbers from CVC Thermoset Specialties, and aliphatic urethane acrylate oligomers from Sartomer. Preferred impact modifiers in dental applications are methacrylate-butadiene-styrene (MBS), acrylic based impact modifiers, silicone based impact modifiers and silicone-acrylic based impact modifiers.

### Stabiliser

The composition according to the aspects of the present invention may comprise at least one suitable stabiliser that stabilises the composition during storage and prevents premature polymerisation by radical polymerisation and/or prevents degradation of the cured polymer in the 3D object. Therefore, the stabiliser may act to extend the compositions shelf life.

Typically, the stabiliser may be a hindered amine light stabiliser. More typically, the stabiliser may be one or more of 4-methoxyphenol, phenothiazine, bistridecylthiodipropionate, sterically hindered monophenols, e.g. 2,6-di-tert-butyl-p-cresol or butylated hydroxy toluene (BHT). Further exemplary stabilisers include alkylated thiobisphenols, e.g. 2,2-methylenebis-(4-methyl-6-tert-butylphenol) and 2,2-bis (1-hydroxy-4-methyl-6-tert-butylphenyl) sulfide.

Suitably, the composition according to aspects of the present invention may comprise two stabilisers. Typically, the stabilisers are selected from 2,6-di-tertiarybutyl-4-methyl phenol and a disubstituted diphenyl amine.

The acrylic monomer of the invention is optionally provided with an accompanying suitable inhibitor such as hydroquinone (HQ), methyl hydroquinone (MeHQ), 2,6-di-tertiary-butyl-4-methoxyphenol (Topanol 0) and 2,4-dimethyl-6-tertiary-butyl phenol (Topanol A).

### Flow Modifier

The composition according to aspects of the present invention may comprise at least one flow modifier to enhance the flow properties of the composition. Suitable flow modifiers include alumina, silica, zinc stearate and stearate coated calcium carbonate.

### Colourants

The composition according to the aspect of the present invention may include suitable colourants to provide a desired colour depending on the application of the 3D printed object. The colourant is therefore not limited to a particular colour and possible colours include for example, white, yellow, orange, black, green, red, pink and/or violet, typically the colourant is pink.

A suitable colourant would be known to the skilled person. A suitable colourant may include various combinations of pigments or dyes.

The amount of colourant in the compositions described herein may be less than about 1.0 wt %, preferably less than about 0.5 wt % based on the total weight of the composition.

Dental products such as dental prosthesis will typically include a colourant to mimic the colour of human gums.

### The Composition

Preferably, the additive manufacturing composition forms a semi-interpenetrating polymer network (SIPN) upon curing. The acrylic polymer of the additive manufacturing composition does not form covalent linkages with the crosslinker or reactive diluent upon curing. Preferably, the acrylic polymer does not form crosslinks in the compositions of the invention. Accordingly, the acrylic polymer may at least partially interpenetrate a polymer network formed from the polymerisation of b) and optionally c), optionally, together with any other added monomers detailed herein, but may be separable therefrom without breaking chemical bonds.

Typically, any articles formed from the additive manufacturing composition described herein comprise a semi-interpenetrating polymer network of the acrylic polymer with the polymerised network of components b) and optionally c), optionally, together with any other added monomers described herein.

The additive manufacturing composition according to any aspects of the present invention may have a viscosity at 25° C. in the range of 50-30,000 cP, typically 80-25,000 cP, more typically 150-20,000 cP.

In a preferred embodiment of the present invention the additive manufacturing composition is a storage stable composition.

According to a further aspect of the present invention, there is provided a process for the production of an additive manufacturing composition as described herein comprising the steps of:
a. at least partially dissolving the acrylic polymer as a solid particulate in the crosslinker and/or the reactive diluent to form a mixture;
b. optionally adding the suitable initiator, co-initiator and/or additive before, during or after step a.

It has been surprisingly been found that at least partially dissolving and mixing the acrylic polymer which may be in the form of a particulate with the crosslinker and/or the reactive diluent as described herein can produce a composition that has improved mechanical properties in the resultant 3D printed object.

Suitably, at least 50 wt % of the acrylic polymer is dissolved in the crosslinker and/or reactive diluent, typically at least 60 wt %, more typically at least 70 wt %, even more typically at least 80 wt %, most typically at least 90 wt %, especially about 100 wt %.

Accordingly, by “partially dissolved” it is meant at least 25 or 50 wt % of the material is dissolved, typically at least 60 wt %, more typically at least 70 or 75 wt %, even more typically at least 80 wt %, most typically at least 90 wt %, especially about 100 wt %.

### Additive Manufacturing

The compositions of the aspects of the present invention are particularly suited for use in additive manufacturing. Therefore, according to a further aspect of the present invention there is provided an additive manufacturing process as claimed herein.

In general, a DLP printer or stereolithography printer or daylight printer can be used for fabricating the three-dimensional object using the composition of this invention. Such printers can operate using either UV or visible light sources.

In either approach, the polymerisable composition is flowable. The printer builds successive layers of the polymerised composition by projecting or irradiating light onto the building plane.

In the present invention, several printable polymerizable compositions with different shades and colour can be prepared and placed into separate reservoirs. Accordingly, when building a denture, the denture base may be built from a denture base shaded reservoir layer by layer. This denture base may then be washed and transferred into an artificial dentin shaded reservoir to build dentin-like teeth on the denture base layer by layer. Subsequently, it may be washed and transferred into an enamel shaded reservoir, so that an enamel like layer is built layer by layer and forms a final denture device with integral teeth on denture base.

Alternatively, only a denture base or only teeth may be prepared by additive manufacturing and then combined with teeth or denture base produced in a different process.

Wash solvents (e.g., ethyl acetate, alcohols, acetone, THF, heptane, etc. or their combinations) may be used to remove uncured resin from 3D objects of the present invention.

Final cure or heat treatment may be used to enhance the mechanical and physical properties of the 3D objects of the present invention as well as their performance.

The compositions developed in this invention can be used in several industries, such as aerospace, animation and entertainment, architecture and art, automotive, consumer goods and packaging, education, electronics, hearing aids, sporting goods, jewellery, medical, manufacturing, etc. When used in the production of dentures, the dentures thus prepared may be either temporary dentures (also known as immediate dentures) or permanent dentures.

The compositions of the aspects of the present invention are particularly suited for use in additive manufacturing. Accordingly, the present invention extends to the use of a composition as described herein in additive manufacturing.

Therefore, according to a further aspect of the present invention there is provided a 3-D printed object such as a dental product, typically, a dental prosthesis comprising a cured additive manufacturing composition as described herein.

Typically, the 3-D printed object such as a dental product, typically, a dental prosthesis has a flexural strength of at least 65 MPa, more typically at least 75 MPa, most typically at least 85 MPa.

Suitably, the 3-D printed object such as a dental product, typically a dental prosthesis has a flexural strength of between 65 and 120 MPa, typically between 75 and 110 MPa, more typically between 85 and 105 MPa.

Typically, the 3-D printed object such as a dental product, typically, a dental prosthesis has a flexural modulus of at least 2000 MPa, more typically at least 2300 MPa, more typically, at least 2500 MPa.

Suitably, the 3-D printed object such as a dental product, typically, a dental prosthesis has a flexural modulus of between 2000 and 4000 MPa, typically between 2300 and 3500 MPa, more typically between 2500 and 3000 MPa.

According to a further aspect of the present invention, there is an additive manufacturing process for the production of a 3-D object such as a dental product, typically a dental prosthesis according to a digital light processing, liquid crystal display screen or a stereolithography method comprising the steps of:
a. forming layers of additive manufacturing composition according to the first aspect of the present invention;
b. curing the said layers sequentially into solid layers to thereby build up the required solid object; and
c. optionally a further curing step.

By forming is meant that the liquid layer forms and the term encompasses the techniques where the composition layers are formed and cured within the liquid reservoir as the 3-D object is gradually formed on a build platform as it moves away from the light source.

The additive manufacturing process may cure the additive manufacturing composition using radiation, typically electromagnetic radiation such as UV or visible light. In a preferred embodiment of the present invention the composition is cured with UV radiation, typically UV radiation in the range of 10-420 nm, more typically 350-415 nm, even more typically 375-410 nm, especially about 385 or 405 or 410 nm to produce a 3-D printed object such as a dental product, typically, a dental prosthesis.

The optional further curing step may occur after the completion of the initial printing of the 3-D printed object. Generally, the further curing step ensures that the composition is fully cured which may result in improving the mechanical properties of the cured composition and therefore final 3-D object such as a dental product, typically, a dental prosthesis.

Accordingly, the present invention extends to a 3-D object such as a dental product, typically, a dental prosthesis that is obtainable by the additive manufacturing process described herein.

The invention also extends to an additive manufacturing cartridge or a replacement hopper for a 3D printer comprising the composition described herein.
According to a further aspect of the present invention, there is the use of a composition for producing a 3-D object such as a dental product, typically, a dental prosthesis with improved mechanical properties comprising:
   a. acrylic polymer having EMA residues,
   b. a crosslinker having at least two reactive terminal groups that are capable of polymerisation, typically, each of the said at least two reactive terminal groups being (alk)acrylate groups, more typically, one or both of the at least two reactive terminal groups are alkacrylate groups, most typically, methacrylate groups,
   c. a reactive diluent in the form of a flowable liquid at 25° C.,
   d. a suitable initiator and optionally a suitable co-initiator.

It will be appreciated that any of the features or optional features set out herein for any of the aspects of the invention may also be applied to any of the other aspects mutatis mutandis.

### Definitions

The term “alky” when used herein, means, unless otherwise specified, a saturated hydrocarbon, typically a C₁ to C₁₂ alkyl and includes methyl, ethyl, propyl, butyl, pentyl, hexyl, heptyl, octyl, nonyl, decyl, undecyl and dodecyl, typically, the alkyl groups are selected from methyl, ethyl, propyl, butyl, pentyl and hexyl, more typically, methyl. Unless otherwise specified, alkyl groups may be linear or branched.

Further, unless otherwise specified, alkyl groups be substituted, unsubstituted or terminated be unsubstituted, substituted or terminated by one or more substituents selected from —OR, —OC(O)R, —C(O)R, —C(O)OR, —NR₂, —C(O)NR₂, —SR, —C(O)SR, —C(S)NR₂, wherein R here and generally herein each independently represent hydrogen, or unsubstituted or substituted alkyl. The alkyl groups are saturated groups, typically, the alkyl groups are unsubstituted, typically, the alkyl groups are linear.

The term “alkenyl” when used herein, means, unless otherwise specified, a unsaturated hydrocarbon, typically a hydrocarbon with at least one carbon-carbon double bond functional group, more typically a C₂ to C₁₂ alkenyl and includes ethenyl, propenyl, butenyl, pentenyl, hexenyl, heptenyl, octenyl, nonenyl, decenyl, undecenyl, dodecenyl, typically the alkenyl groups are selected from ethenyl, propenyl, butenyl, penentyl and hexenyl, more typically, ethenyl. Unless otherwise specified, alkenyl groups may be linear or branched. Further, unless otherwise specified, alkenyl groups be substituted, unsubstituted or terminated be unsubstituted, substituted or terminated by one or more substituents selected from —OR, —OC(O)R, —C(O)R, —C(O)OR, —NR₂, —C(O)NR₂, —SR, —C(O)SR, —C(S)NR₂, wherein R here and generally herein each independently represent hydrogen, or unsubstituted or substituted alkyl or alkenyl. The alkenyl groups are unsaturated groups, typically, the alkenyl groups are unsubstituted, typically, the alkenyl groups are linear.

The term “cycloalkyl” when used herein, means, unless otherwise specified, a cyclic saturated hydrocarbon, typically a cyclic C₃ to C₁₂ alkyl and includes cyclopropyl, cyclobutyl, cyclopentyl, cyclohexyl, cycloheptyl, cyclooctyl, cyclononyl, cyclodecyl, cycloundecyl and cyclododecyl, typically, the cycloalkyl groups are selected from cyclopropyl, cyclobutyl, cyclopentyl and cyclohexyl, more typically cyclohexyl. Unless otherwise specified, cycloalkyl groups may comprise branched portions.

Further, unless otherwise specified, cycloalkyl groups may be substituted, unsubstituted or terminated by one or more substituents selected from —OR, —OC(O)R, —C(O)R, —C(O)OR, —NR₂, —C(O)NR₂, —SR, —C(O)SR, —C(S)NR₂, wherein R here and generally herein each independently represent hydrogen, or unsubstituted or substituted alkyl. The cycloalkyl groups are saturated groups, typically, the cycloalkyl groups are unsubstituted.

The term “a/k” or the like should, in the absence of information to the contrary, be taken to be in accordance with the above definition of “alkyl” and wherein the parenthesised (alk) term means the presence of alkyl is optional and wherein “C₀ alk” also means non-substituted with an alkyl.

The term “bulky side group” when used herein, means, unless otherwise specified, a bulky alkyl, cyclic or aryl group, typically the bulky alkyl group herein is a C₄-C₂₀ alkyl group that contains one or more tertiary and/or quaternary carbons, more typically, a C₄-C₁₅ alkyl group that contains one or more tertiary and/or quaternary carbons. Typically, the cyclic group is a C₅-C₂₀ cyclic alkyl or alkenyl group, more typically, the cyclic group is a C₅-C₁₅ cyclic alkyl of alkenyl group. Typically, the aryl group is a C₅-C₂₀ aryl group, more typically, a C₅-C₁₅ aryl group. The bulky side group may be a combination of a bulky alkyl, cyclic or aryl group. The bulky alkyl, cyclic or aryl groups or combination thereof may contain one or more heteroatoms which interrupt the carbon chain of said groups wherein the heteroatoms are preferably selected from sulphur, oxygen or nitrogen, more preferably, oxygen or nitrogen. Suitably, the chain of carbon atoms may be interrupted by up to 3, more typically, 2 or most typically, 1 heteroatom, It is understood that a bulky side group should be sufficiently bulky to provide the required steric hinderance to the parent molecule to serve as a reactive diluent as defined herein. The term “bulky” or “steric hinderance” does not require a definition because it is well understood by the skilled person.

By “storage stable” is meant that the composition does not polymerize under normally acceptable storage conditions of temperature and time i.e. between 5 and 30° C. and 1 to 10 days, more typically, 15 to 25° C. and 1 to 170 days, most typically, between 15 to 25° C. and 1 to 250 days.

Alternatively, by “storage stable” is meant the composition remains as a free-flowing liquid. Typically, the composition has a viscosity at 25° C. of 50-20,000 cP, typically for a period of at least 1 day from initial mixing, more typically, at least 1, 2, 3, 4, 5 or 6 months from initial mixing, more typically at least 12 months, most typically at least 24 months from initial mixing. Accordingly, the composition remains a free flowing liquid until the initiator is activated.

The term “liquid” herein does not require definition because it is well understood by the skilled person. However, for the avoidance of doubt it includes a flowable material including a slurry or a paste. Typically, the term liquid applies at least between 5 and 35° C., more typically, between 5 and 30° C.

The term “bridge” in relation to the bridging group means the atoms in the bridge between the reactive terminal groups and does not include the atoms that are substituents of the atoms in the bridge.

The term “dental prosthesis” includes dentures and typically includes a denture base and/or artificial teeth.

Temperatures given herein are generally at atmospheric pressure (1 atm/101 KPa) unless indicated otherwise.

The mean particle size of the acrylic polymer beads may be determined using a Coulter LS230 laser diffraction instrument.

Molecular weight may be determined by gel permeation chromatography (GPC). Unless indicated otherwise, viscosity herein means Brookfield Viscosity (BV, centipoise (cP)) and may be measured using a Brookfield Viscometer model RVDV-E at 25° C.

Embodiments of the invention will now be defined by reference to the accompanying examples.

### EXPERIMENTAL

### Characterisation Techniques

The mean particle size of the acrylic polymer beads is determined using a Coulter LS230 laser diffraction instrument.

Molecular weight is determined by gel permeation chromatography (GPC) using tetrahydrofuran solvent and a refractive index detector calibrated using poly(methyl methacrylate) standards.

Brookfield Viscosity (BV, centipoise (cP)) was carried out using a Brookfield Viscometer model RVDV-E at 25° C.

Flexural strength, flexural modulus, fracture toughness and total work of fracture were determined according to ISO 20795-1:2013 Dentistry—Base polymers—Part 1: Denture base polymers.

Shore D hardness is measured using a durometer according to ASTM D2240.

### Example 1

A 13 wt % solids solution of PEMA in a mixture of 30 parts urethane dimethacrylate (UDMA) oligomer and 70 parts triethylene glycol dimethacrylate (TEGDMA) monomer/crosslinker was prepared as follows: TEGDMA (107.8 grams) and UDMA (Ebecryl 4859) (46.2 grams) were added to a glass jar placed in a water bath. A 4-blade impeller connected to an overhead stirrer was fitted to the glass jar and PEMA powder (Colacryl® TS1364/1, available from Lucite International Speciality Polymers and Resins Ltd)) (26.0 grams) was added to the monomer/oligomer mixture whilst stirring. Silica filler (20.0 grams) was also added. The mixture was heated to 80° C. using the water bath and stirring was maintained for 4 hours until the PEMA had dissolved. After cooling to room temperature, the Brookfield viscosity was measured to be 19,600 cP. A portion of the solution (130 grams) was weighed into an opaque beaker with lid before then dissolving Diphenyl (2,4,6-trimethylbenzoyl) phosphine oxide TPO (0.65 grams) by stirring for 1 hour at room temperature using an overhead stirrer, taking care to exclude light.

The above liquid formulation was loaded into the resin bath of Photocentric's LC Dental 3D printer equipped with LCD display operating with UV light (410 nm). Test parts (e.g. straight bars for flexural strength and modulus testing) were 3D printed using a cure speed of 2 seconds and layer thickness of 50 microns. 3D printing conditions were as follows:
Exposure Time=2 secs
Bottom Exposure=20 secs
# of Bottom Layers=4
Layer Thickness=50 μm
Z Lift Distance=10 mm
Z Lift Speed=50 mm/min
Z Bottom Speed=50 mm/min
Z Retract Speed=500 mm/min

The test parts were then post-cured under UV light (405 nm) for 180 minutes at 72° C. in a Formlabs Formcure post cure box.

Mechanical property testing of the printed parts gave the following results.

| | |
|---|---|
| Flexural Strength/MPa | 86 |
| Flexural Modulus/MPa | 2,100 |
| Fracture Toughness/MPa · m^{1/2} | 0.93 |
| Total Work of Fracture/N/m | 129.3 |
| Shore D hardness | 90 |

### Comparative Example 1

As example 1 but omit the PEMA powder and silica filler. Mechanical property testing of the printed parts gave the following results.

| | |
|---|---|
| Flexural Strength/MPa | 72 |
| Flexural Modulus/MPa | 1,500 |
| Shore D hardness | 89 |

### Comparative Example 2

As example 1 but replace the PEMA polymer and silica filler with the same mass of ethyl methacrylate (EMA) monomer. This resulted in an unsuccessful 3D printing run. The printed test bars were not fully formed and tended to break when removed from the printer.

### Example 2

A 4.2 wt % solids solution of PEMA in a mixture of 80 parts bisphenol A (EO)4 dimethacrylate oligomer and 20 parts isobornyl methacrylate (IBOMA) monomer was prepared as follows:

Bisphenol A (EO)4 dimethacrylate (Miramer® M241, available from Miwon Speciality Chemical Co., Ltd.) (76.64 grams) and IBOMA (19.16 grams) were added to a glass jar placed in a water bath. A 4-blade impeller connected to an overhead stirrer was fitted to the glass jar and PEMA powder (Colacryl® TS1364/1, available from Lucite International Speciality Polymers and Resins Ltd)) (4.20 grams) was added to the monomer/oligomer mixture whilst stirring. The mixture was heated to 80° C. using the water bath and stirring was maintained for 4 hours until the PEMA had dissolved. After cooling to room temperature, the Brookfield viscosity was measured to be 2100 cP. Bis(2,4,6-trimethylbenzoyl)-phenylphosphineoxide photoinitiator (BAPO), Irgacure 819, available from IGM Resins B.V. (0.75 grams) was added and stirring carried out to ensure a homogeneous mixture. The mixture was maintained at room temperature under the exclusion of light for 2-4 hours prior to 3D printing.

The above liquid formulation was loaded into the resin bath of Photocentric's LC Dental 1.5 3D printer equipped with LCD display operating with UV light (410 nm). Test parts (e.g. straight bars for flexural strength and modulus testing) were 3D printed using a cure speed of 2 seconds and layer thickness of 50 microns. 3D printing conditions were as follows:
Exposure Time=2 secs
Bottom Exposure=20 secs
# of Bottom Layers=4
Layer Thickness=50 μm
Z Lift Distance=10 mm
Z Lift Speed=50 mm/min
Z Bottom Speed=50 mm/min
Z Retract Speed=500 mm/min

The test parts were then post-cured under UV light (405 nm) for 180 minutes at 72° C. in a Formlabs Formcure post cure box.

Mechanical property testing of the printed parts gave the following results.

| | |
|---|---|
| Flexural Strength/MPa | 102.5 |
| Flexural Modulus/MPa | 2,617 |
| Fracture Toughness/MPa · m^{1/2} | 0.75 |
| Shore D hardness | 90 |

### Comparative Example 3

As example 2, but omit the PEMA powder. Mechanical property testing of the printed parts gave the following result.

| | |
|---|---|
| Flexural Strength/MPa | 70.3 |
| Shore D hardness | 88 |

### Comparative Example 4

A 7 wt % solids solution of PMMA in a mixture of 30 parts urethane dimethacrylate (UDMA) oligomer and 70 parts triethylene glycol dimethacrylate (TEGDMA) monomer/crosslinker was prepared as follows: TEGDMA (116.2) and UDMA (Ebecryl 4859) (49.8 grams) were added to a glass jar placed in a water bath. A 4-blade impeller connected to an overhead stirrer was fitted to the glass jar and PMMA powder (Colacryl® LS 600/1, available from Lucite International Speciality Polymers and Resins Ltd)) (14.0 grams) was added to the monomer/oligomer mixture whilst stirring. Silica filler (20.0 grams) was also added. The mixture was heated to 80° C. using the water bath and stirring was maintained for 4 hours until the PMMA had dissolved. After cooling to room temperature, the Brookfield viscosity was measured to be 17,320 cP. The solution was weighed into an opaque beaker with lid before then dissolving Irgacure 819BAPO (0.75 grams) by stirring for 1 hour at room temperature using an overhead stirrer, taking care to exclude light.

The above liquid formulation was loaded into the resin bath of Photocentric's LC Dental 3D printer equipped with LCD display operating with UV light (410 nm). Test parts (e.g. straight bars for flexural strength and modulus testing) were 3D printed using a cure speed of 2 seconds and layer thickness of 50 microns. 3D printing conditions were as follows:
Exposure Time=2 secs
Bottom Exposure=20 secs
# of Bottom Layers=4
Layer Thickness=50 μm
Z Lift Distance=10 mm
Z Lift Speed=50 mm/min
Z Bottom Speed=50 mm/min
Z Retract Speed=500 mm/min

The test parts were then post-cured under UV light (405 nm) for 180 minutes at 72° C. in a Formlabs Formcure post cure box.

Mechanical property testing of the printed parts gave the following results.

| | |
|---|---|
| Flexural Modulus/MPa | 1,900 |

### Examples 3 to 5

Example 2 was repeated except isobornyl methacrylate (IBOMA) monomer was replaced with the same amount of either cyclohexyl methacrylate (CHMA) (example 3), tetrahydrofurfuryl methacrylate (THFMA) (example 4) or t-butyl methacrylate (tBMA) (example 5). As with example 2, the test parts produced by examples 3 to 5 were strong and hard. Shore D hardness testing of the test specimens gave the following results.

| | Mononer used as replacement | Shore D |
|---|---|---|
| Example | for IBOMA | Hardness |
| 3 | CHMA | 90 |
| 4 | THFMA | 89 |
| 5 | tBMA | 90 |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the preferred, typical or optional invention features disclosed in this specification (including any accompanying claims, abstract or drawings), or to any novel one, or any novel combination, of the preferred, typical or optional invention steps of any method or process so disclosed.

1. An additive manufacturing composition for a 3-D printed object comprising:
a. an acrylic polymer having ethyl methacrylate (EMA) residues,
b. a crosslinker having at least two reactive terminal groups that are capable of polymerisation,
c. a reactive diluent in the form of a flowable liquid at 25° C.,
d. a suitable initiator and optionally a suitable co-initiator,
wherein the amount of the acrylic polymer is between 0.2 and 20 wt % of the total weight of the composition.

2. An additive manufacturing composition for a 3-D printed object according to claim 1, wherein the reactive diluent has a viscosity at 25° C. in the range of 1 to 8,000 cP.

3. An additive manufacturing composition according to claim 1, wherein the acrylic polymer comprises more than 50% EMA residues relative to total monomer residues.

4-5. (canceled)

6. An additive manufacturing composition according to claim 1, wherein the crosslinker is between 5 to 94 wt % of the total weight of the composition.

7. An additive manufacturing composition according to claim 1, wherein the crosslinker comprises a bridging group, wherein the bridging group of the crosslinker has a molecular weight (Mw) of 150 g/mol to 5,000 g/mol.

8. (canceled)

9. An additive manufacturing composition according to claim 1, wherein the crosslinker is selected from the groups consisting of one or more of urethane dimethacrylate (UDMA), bisphenol A dimethacrylate (BPAMA), bisphenol A ethoxylate dimethacrylate (BPAEDMA), and bisphenol A-glycidyl methacrylate (bis-GMA), typically one or more of Ebecryl® 4859 and bisphenol A (EO)₄ dimethacrylate.

10. (canceled)

11. An additive manufacturing composition according to claim 1, wherein the reactive diluent comprises one or more primary monomers having at least two reactive monomer units or a single reactive monomer unit and a bulky side group and optionally, one or more auxiliary monomers.

12. (canceled)

13. An additive manufacturing composition according to claim 11, wherein the primary monomer is selected from one or more of ethylene glycol dimethacrylate (EGDMA), diethylene glycol dimethacrylate (DEGDMA), triethylene glycol dimethacrylate (TEGDMA), tetraethyleneglycol dimethacrylate, polyethyleneglycol dimethacrylate, 2,2-bis[4(methacryloxyethoxy)phenyl]propane, 1,6-hexanediol dimethacrylate, tripropylene glycol dimethacrylate, butanediol dimethacrylate, neopentyl glycol dimethacrylate, dipropylene glycol dimethacrylate, tripropylene glycol trimethacrylate, trimethylol propane trimethacrylate, ethoxylated trimethylolpropane trimethacrylate, pentaerythritol trimethacrylate, propoxylated glyceryl trimethacrylate, propoxylated trimethylolpropane trimethacrylate, ditrimethylolpropane tetramethacrylate, ditrimethylol pentaerythritol tetramethacrylate, dipentaerythritol hexamethacrylate, isobornyl methacrylate (IOBMA), cyclohexyl methacrylate (CHMA), t-butyl methacrylate (TBMA), dicyclopentenyl methacrylate, dihydrodicyclopentadienyl methacrylate, adamantyl methacrylate, 4-t-butylcyclohexyl methacrylate, 3,3,5-trimethylcyclohexyl methacrylate, tetrahydrofurfuryl methacrylate, benzyl methacrylate, 2-phenoxyethylmethacrylate and phenyl methacrylate.

14-16. (canceled)

17. An additive manufacturing composition according to claim 1, wherein the one or more of the initiator and/or co-initiator is a photo-initiator suitable to cause polymerisation to be initiated upon exposure to UV and/or visible wavelengths of light.

18-21. (canceled)

22. An additive manufacturing composition according to claim 1, wherein the viscosity of the composition at 25° C. is in the range of 50-30,000 cP.

23-24. (canceled)

25. An additive manufacturing composition according to claim 1, wherein the crosslinker and/or reactive diluent is a liquid at 25° C.

26. An additive manufacturing composition according to claim 1, wherein the additive manufacturing composition is a flowable liquid at additive manufacturing operating temperatures.

27. An additive manufacturing composition, according to claim 1, wherein if component b) is a flowable liquid at 25° C., the reactive diluent has a viscosity below that of component b) at 25° C.

28. An additive manufacturing composition according to claim 1, wherein component a) is at least partially dissolved in the composition.

29. A process for the production of an additive manufacturing composition comprising:
i. an acrylic polymer having ethyl methacrylate (EMA) residues,
ii. a crosslinker having at least two reactive terminal groups that are capable of polymerisation,
iii. a reactive diluent in the form of a flowable liquid at 25° C.,
iv. a suitable initiator and optionally a suitable co-initiator;
the process comprising the steps of:
i. at least partially dissolving the acrylic polymer as a solid particulate in the crosslinker and/or the reactive diluent to form a mixture,
ii. optionally adding the suitable initiator, co-initiator and/or additive before, during or after step i.

30. A process for the production of an additive manufacturing composition according to claim 29, wherein at least 50 wt % of the acrylic polymer is dissolved in the crosslinker and/or reactive diluent.

31. A 3-D printed object comprising a cured additive manufacturing composition comprising:
i. an acrylic polymer having ethyl methacrylate (EMA) residues,
ii. a crosslinker having at least two reactive terminal groups that are capable of polymerisation,
iii. a reactive diluent in the form of a flowable liquid at 25° C.,
iv. a suitable initiator and optionally a suitable co-initiator.

32. A 3-D printed object according to claim 31 wherein the flexural strength is between 65 and 120 MPa.

33. A 3-D printed object according to claim 31 wherein the flexural modulus is between 2000 and 4000 MPa.

34. An additive manufacturing process for the production of a 3-D printed object according to a digital light processing, stereolithography or LCD screen method comprising the steps of:
i. forming layers of additive manufacturing composition;
comprising:
i. an acrylic polymer having ethyl methacrylate (EMA) residues,
ii. a crosslinker having at least two reactive terminal groups that are capable of polymerisation,
iii. a reactive diluent in the form of a flowable liquid at 25° C.,
iv. a suitable initiator and optionally a suitable co-initiator;
ii. curing the said layers sequentially into solid layers to thereby build up the required solid object; and
iii. optionally a further curing step.

35-40. (canceled)

41. An additive manufacturing composition according to claim 1, wherein each of the said at least two reactive terminal groups of the crosslinker are (alk)acrylate groups.
